(19) United States
(12) Patent Application Publication
(10) Pub. No.: US 2013/0277138 A1
(43) Pub. Date: Oct. 24, 2013

(54) MOTOR DRIVE APPARATUS

(71) Applicant: DENSO CORPORATION, Kariya-city (JP)

(72) Inventors: Kanta ARAI, Kariya-city (JP); Toshihisa YAMAMOTO, Anjo-city (JP)

(73) Assignee: Denso Corporation, Kariya-city (JP)

(21) Appl. No.: 13/860,046

(22) Filed: Apr. 10, 2013

(30) Foreign Application Priority Data
Apr. 18, 2012 (JP) 2012-94707

(51) Int. Cl. H02H 7/08; B62D 5/04

(52) U.S. Cl. CPC H02H 7/0833; B62D 5/04
USPC 180/443; 361/33

(57) ABSTRACT

A motor drive apparatus includes a back EMF detection element and a protection control circuit. When a voltage detected by the back EMF detection element exceeds a threshold voltage of a Zener diode, a voltage signal is applied to a sensing gate through a detection signal line to sequentially turn on switching element of the low-side arm. A current caused by the back EMF applied to a drive circuit flows to the ground through the switching element of the low-side arm in an on-state. Thus a braking torque is applied to a motor, which is driven to rotate by an external force, and hence the back EMF is reduced. Switching elements in the drive circuit are thus protected from the excessive voltage.

### CROSS REFERENCE TO RELATED APPLICATION

This application is based on and incorporates herein by reference Japanese patent application No. 2012-94707 filed on Apr. 18, 2012.

### TECHNICAL FIELD

The present disclosure relates to a motor drive apparatus for driving a motor, which is incorporated in an electric power steering system, for example.

### BACKGROUND

A conventional motor drive apparatus includes a drive circuit, which is formed of a plurality of switching elements. For example, the drive circuit includes an inverter circuit, which converts a DC power to a three-phase AC power to drive a three-phase AC motor.

In an example of a motor drive apparatus, which drives a steering assist motor in an electric power steering system of a vehicle, a vehicle is often jacked up and a steering wheel is rotated with its ignition in an off-state in a car repair shop or a car dealer. In this case, the motor operates as a generator and generates a counter-electromotive force (back EMF). In a case that the motor drive apparatus interrupts the DC power supply to the drive circuit when an ignition switch is turned off, it is not possible to regenerate the induced back EMF toward the DC power source. The back EMF is thus applied to the drive circuit and possibly causes erroneous operations and breakdown of the switching elements by an excessive voltage.

JP-A-2010-254128 (US 2010/0270958 A1) discloses a configuration, in which a motor relay is provided in each phase between a drive circuit and a motor. The motor relay turns off in the ignition-off state thereby to interrupt electric connection between the drive circuit and the motor. As a result, even when a steering wheel is rotated in the ignition-off state and a back EMF is generated in the motor, the back EMF is not applied to the drive circuit. Switching elements of the drive circuit are thus protected from the excessive voltage of the back EMF.

According to the configuration described above, a plurality of motor relays, each of which may be either a switching element or a mechanical relay, need be provided between the drive circuit and the motor in correspondence to the number of phases of the motor. Such motor relays are not desirable from a standpoint of a size of the apparatus, number of circuit components, and cost. In a case that the motor relay is short-circuited by failure, the resulting configuration is the same as a case, in which the motor relay is not provided. The switching elements of the drive circuit cannot be protected from the back EMF.

### SUMMARY

It is therefore an object to provide a motor drive apparatus, which protects switching elements of a drive circuit from a counter-electromotive force generated in a motor when rotated by an external force under an ignition-off state, that is, the drive circuit is not connected to a DC power source.

According to one aspect, a motor drive apparatus is provided for a motor of a plurality of phases. The motor drive apparatus comprises a drive circuit, a power supply on/off circuit, a drive control circuit, a back EMF detection circuit and a protection control circuit.

The drive circuit includes a plurality of switching elements forming a high-side arm and a low-side arm of a bridge circuit and drives the motor by converting electric power of a DC power source.

The power supply on/off circuit conducts and interrupts electric connection between the DC power source and the drive circuit.

The drive control circuit controls the plurality of switching elements to turn on and off when the drive circuit drives the motor, and turns off the plurality of switching elements when the electric connection is interrupted by the power supply on/off circuit.

The back EMF detection circuit, which detects whether a back EMF is generated with respect to each phase.

The protection control circuit, which turns on at least the switching element forming the low-side arm of a predetermined phase, when the back EMF detection circuit detects the back EMF in any one of the phases under a state of interruption of the electric connection by the power supply on/off circuit, the predetermined phase corresponding to the phase in which the back EMF is detected.

### BRIEF DESCRIPTION OF THE DRAWINGS

The above and other objects, features and advantages will become more apparent from the following detailed description made with reference to the accompanying drawings. In the drawings:

FIG. 1 is a circuit diagram of a motor drive apparatus according to a first embodiment;

FIG. 2 is a schematic view of an electric power steering system, to which the motor drive apparatus according to the first embodiment is incorporated;

FIG. 3 is a sequence chart of drive circuit protection processing performed by the motor drive apparatus according to the first embodiment;

FIG. 4 is a circuit diagram of a motor drive apparatus according to a second embodiment;

FIG. 5 is a sequence chart of drive circuit protection processing performed by the motor drive apparatus according to the second embodiment; and

FIG. 6 is a sequence chart of events, which arises in a comparative example when a counter-electromotive force is generated.

### DETAILED DESCRIPTION OF THE EMBODIMENT

A motor drive apparatus will be described with reference to embodiments, which are incorporated in an electric power steering system of a vehicle.

### First Embodiment

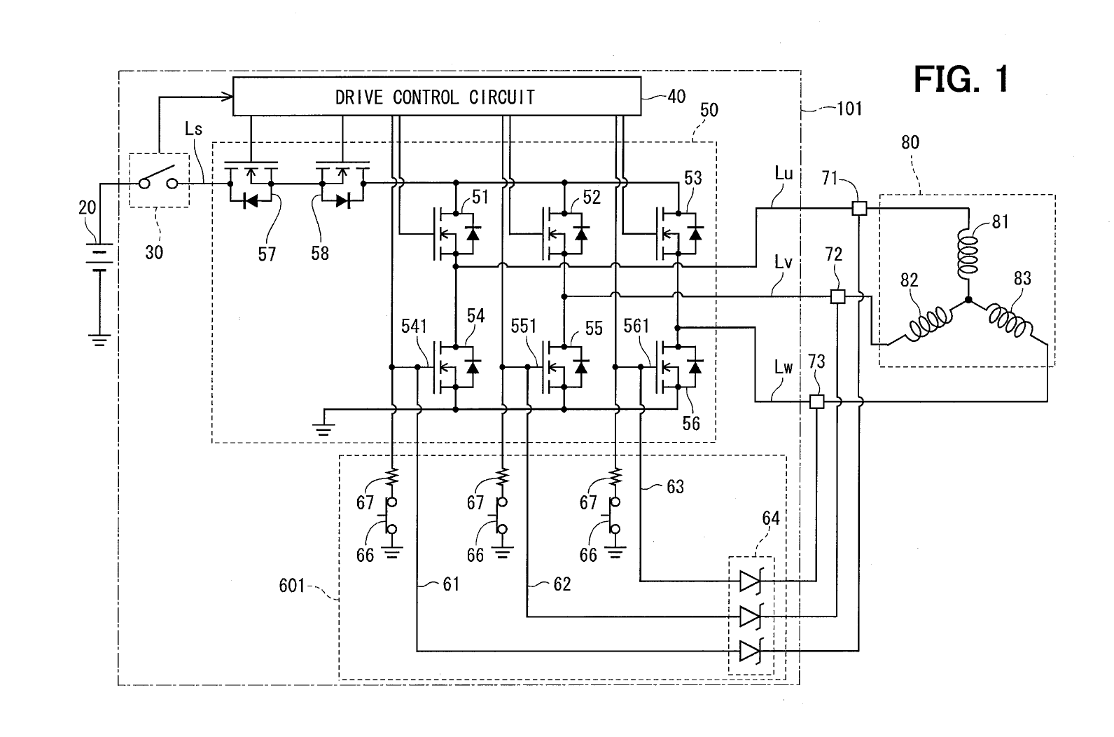

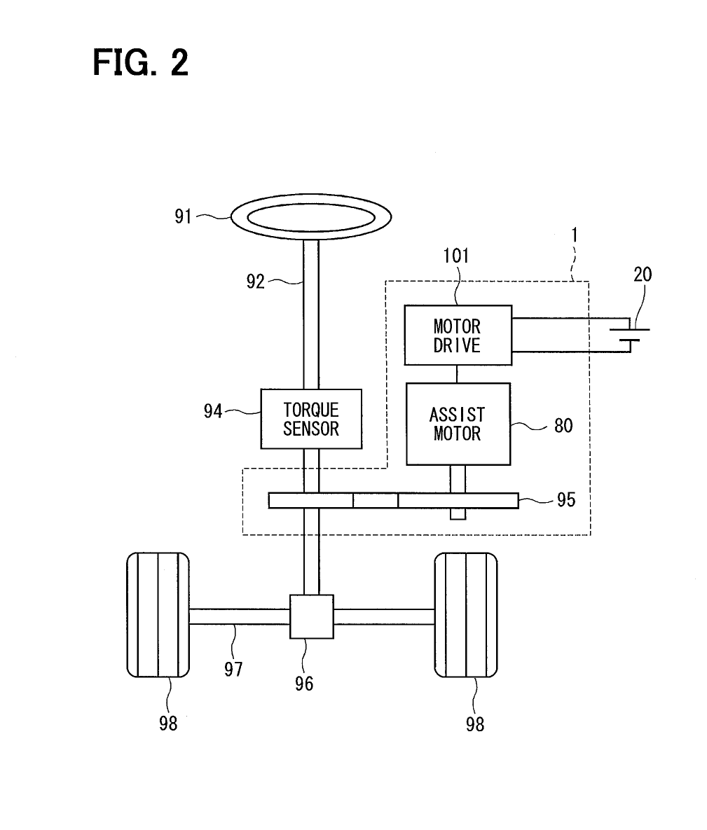

Referring to FIG. 1 to FIG. 3 showing a first embodiment, particularly FIG. 2, an electric power steering system 1 is configured to provide a steering assist torque to a steering shaft 92 of a vehicle for assisting a steering torque of a driver. A torque sensor 9 is attached to the steering shaft 92, which is coupled to a steering wheel 91, for detecting the steering torque. A pinion gear 96 is attached to a top end of the steering shaft 92 and engaged with a rack shaft 97. A pair of tire wheels 98 is rotatably coupled to both ends of the rack shaft 97 through tie rods and the like. The pinion gear 96 converts a rotary movement of the steering shaft 92 to a linear movement of the rack shaft 97 so that the pair of tire wheels 98 is steered by an angle corresponding to an amount of the linear movement of the rack shaft 97.

The electric power steering system 1 is formed of a steering assist motor 80, a speed reduction gear 95 and a motor drive apparatus 101. The motor 80 generates the steering assist torque. The speed reduction gear 95 is a motive power transfer device, which transfers the rotary output of the motor 80 to the steering shaft 92 after motor rotation speed reduction. The motor drive apparatus 101 drives the motor 80. The motor 80 is a three-phase AC brushless motor.

As shown in FIG. 1, the motor drive apparatus 101 includes an ignition switch 30, a drive control circuit 40, a drive circuit 50 and a protection control circuit 601. The motor drive apparatus 101 drives the motor 80 by converting an electric power supplied from a DC battery 20 provided as a DC power source. The ignition switch 30 is provided as a power supply on/off circuit to control an electric connection between the battery 20 and the drive circuit 50. It interrupts the power supply, when turned off for parking the vehicle, for example. The drive control circuit 40 drives the inverter circuit by controlling on/off states of switching elements 51 to 56 of the drive circuit 50, when the ignition switch 30 is in the on-state.

The drive circuit 50 includes a total of eight switching elements 51 to 58. The six switching elements 51 to 56 form high-side arms and low-side arms of a three-phase inverter circuit. Two switching elements 57 and 58 form a power supply relay. The switching elements 51 to 58 are, for example, MOSFETs, that is, metal-oxide-semiconductor field-effect transistors.

The switching elements 57 and 58 for the power supply relay are connected in series in a power supply line Ls between the battery 20 and the inverter circuit with respective parasitic diodes being arranged in reverse directions. The switching elements 57 and 58 for the power supply relay are turned off by control signals from the drive control circuit 40 to interrupt the power supply from the battery 20 to the inverter circuit, in a case that any one of the switching elements 51 to 56 of the high-side arms and the low-side arms fails while the inverter circuit is in operation for driving the motor 80. The switching elements 57 and 58 are connected with respective parasitic diodes being arranged in reverse directions to each other. Thus under a state that the battery 20 is connected in reverse through error, no current flows through the parasitic diodes when the switching elements 57 and 58 are both turned off.

Each switching element 51, 52, 53 of the high-side arm is connected to the power supply line Ls at its drain. A source of the switching element 51, 52, 53 of the high-side arm is connected to a drain of the switching element 54, 55, 56 of the low-side arm connected to the corresponding high-side arm. A source of the switching element 54, 55, 56 of the low-side arm is grounded. Junctions between the switching elements 51, 52 and 53 of the high-side arms and the switching elements 54, 55 and 56 of the low-side arms are connected to terminals of coils 81, 82 and 83 of the motor 80 through motor power lines Lu, Lv and Lw, respectively. Counter-electromotive force (back EMF) detection circuits 71, 72 and 73, which detect back EMFs generated by the coils 81, 82 and 83 are provided in the motor power lines Lu, Lv and Lw, respectively.

The switching element 51 to 56 is turned on and off by a switching signal applied from the drive control circuit 40 to its gate so that the power supply to the motor 80 is switched over. The inverter circuit thus drives the motor 80 by converting the DC power of the battery 20 to the three-phase AC power. The drive control circuit 40 turns off all the switching elements 51 to 56 when the ignition switch 30 is turned off. The gates of the switching elements 54, 55 and 56 of the low-side arms are specifically indicated as sensing gates 541, 551 and 561, respectively.

The protection control circuit 601 includes, for each phase, detection signal lines 61, 62 and 63, Zener diodes 64 as threshold voltage setting devices, grounding switches 66 as connection switches and resistors 67. The detection signal line 61, 62, 63 connects the corresponding sensing gate 541, 551, 561 and a corresponding back EMF detection element 71, 72, 73 of each phase. The Zener diode 64 is provided in each detection signal line 61, 62, 63. The anode and the cathode of the Zener diode 64 is connected to the gate 541, 551, 561 and the back EMF detection element 71, 72, 73.

The grounding switches 66 are connected between the gates 541, 551, 561 and the ground through resistors 67, respectively. The grounding switch 66 is turned on and off in a linked manner with the ignition switch 30. The grounding switch 66 is further tuned on to a current conduction state and turned off to a current interruption state by the drive control circuit 40, when the ignition switch 30 is in the off-state shown in FIG. 1.

Specifically, when the inverter circuit operates normally with the ignition switch 30 being turned on, the grounding switch 66 is in the current interruption state and do not affect the normal driving operation of the inverter circuit. When the ignition switch 30 is turned off, however, the grounding switch 66 is turned on to the current conduction state and the motor drive apparatus 101 operates as described below.

The protection control circuit 601 operates primarily when the ignition switch 30 is turned off to park the vehicle after travel, for example. When a voltage at the back EMF detection element 71, 72, 73 side is lower than a predetermined threshold voltage Vt of the Zener diode 64, no current flows from the back EMF detection element 71, 72, 73 side to the gate 541, 551, 561 side. When the back EMF is generated in the motor 80 and the voltage at the back EMF detection element 71, 72, 73 side exceeds the threshold voltage Vt of the Zener diode 64, however, a current flows to the gate 541, 551, 561 side through the detection signal line 61, 62, 63.

Thus, a voltage signal is applied to the gate 541, 551, 561 and the switching element 54, 55, 56 of the low-side arm turns on. Further the current flows to the ground through the grounding switch 66, which is in the on-state. It is thus possible to protect the gate 541, 551, 561 from being subjected to the excessive voltage higher than the threshold voltage Vt. That is, the resistance of the resistor 67 is determined so that a voltage signal of an appropriate magnitude may be applied to the gate 541, 551, 561.

The motor drive apparatus 101 provides the following operation and advantage relative to a comparative example.

The comparative example is configured to have no protection control circuit 601 in the configuration of the first embodiment shown in FIG. 1. The same parts as the first embodiment are denoted by the same reference numerals. In the comparative example, it is assumed that a motor is rotated by an external force and operates as a generator under a state, in which a motor drive apparatus is not operating. This assumption corresponds to a case, in which the vehicle is jacked up and a steering wheel is rotated with its ignition in the off-state in a car repair shop or a car dealer.

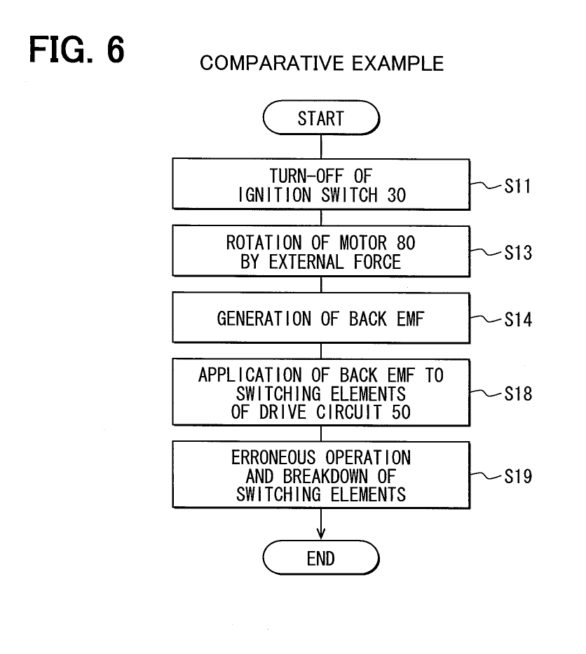

FIG. 6 shows a representative sequence of events, which occur in the above-described comparative example, in a sequence chart form. The sequence chart of FIG. 6 does not include control processing, which the motor drive apparatus 101, particularly the protection control circuit 601, performs. A reference symbol S in FIG. 6 indicates a stage of event. At S11 in FIG. 6, the ignition switch 30 is assumed to be turned off. Then the motor 80 is rotated by an external force at S13, the back EMF is generated at S14 and the back EMF is applied to the switching elements of the drive circuit 50 at S18. Since no protective function is provided against the back EMF in the comparative example, it is likely that the switching element 58 of the power supply relay at the inverter circuit side and the like, for example, operates erroneously and breaks down.

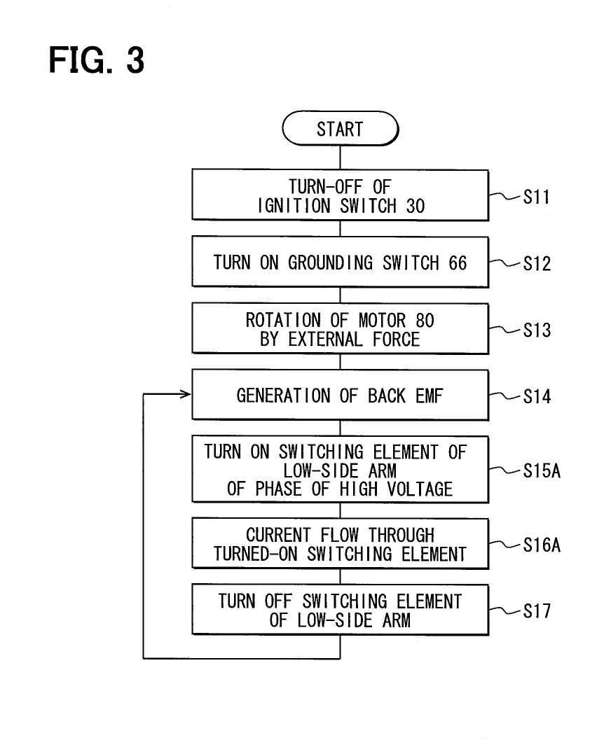

The motor drive apparatus 101 according to the first embodiment performs drive circuit protection processing shown in FIG. 3 by the above-described configuration. In FIG. 3, following S11, the grounding switch 66 is turned on (conducted). S13 and S14 are the same as in the comparative example shown in FIG. 6. When the back EMF is detected by any of the back EMF detection elements 71, 72, 73 and exceeds the threshold voltage Vt at S14, a voltage signal is applied to the gate 541, 551, 561 of the phase, in which the back EMF is higher than the threshold voltage Vt to break down the Zener diode 64. At S15A, the switching element of the low-side arm of the phase, in which the back EMF is high, is turned on. By S15A, the current flows to the ground though the tuned-on switching element among the switching elements 54, 55, 56 of the low-side arms. With this current flow, the back EMF falls and the switching elements 51 to 58 of the drive circuit 50 is protected from the excessive voltage (S16A).

When the back EMF falls below the threshold voltage Vt, the turned-on switching element of the low-side arm is turned off (S17). If the back EMF continues to be high or rises again (S14) exceeding the threshold voltage Vt, the switching element of the low-side arm is turned on again (S15A). Thus the drive circuit protection processing including S15A and S17 is repeated.

### Second Embodiment

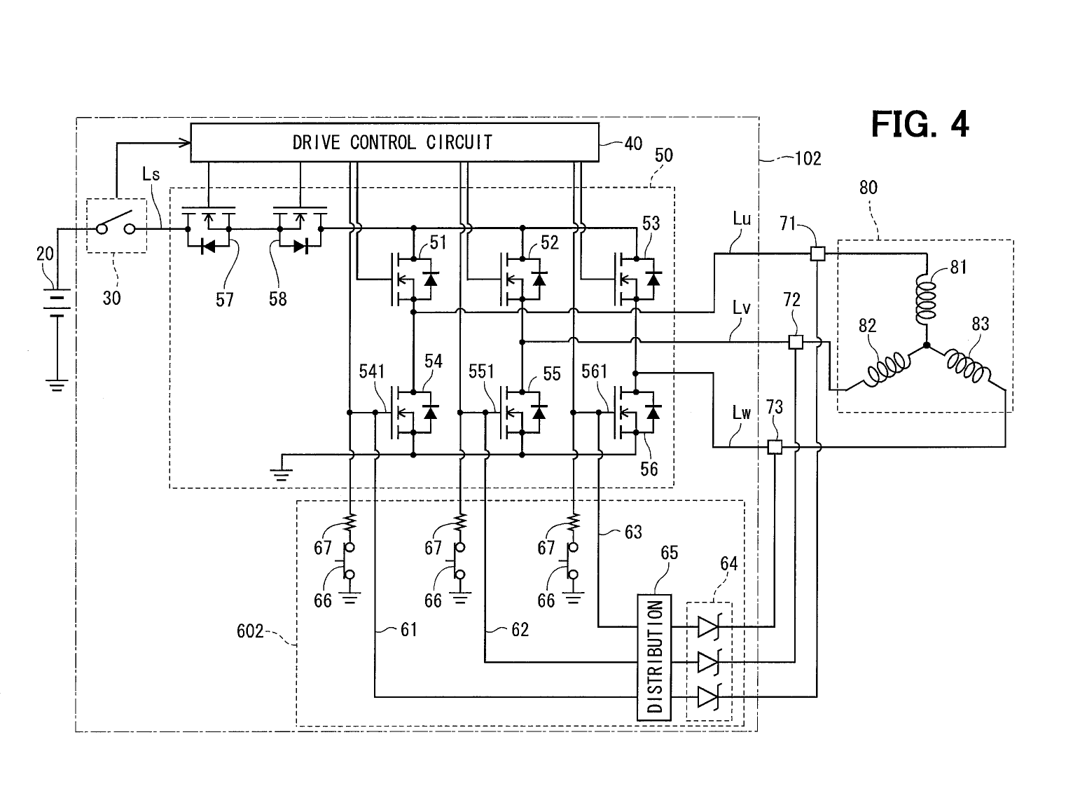

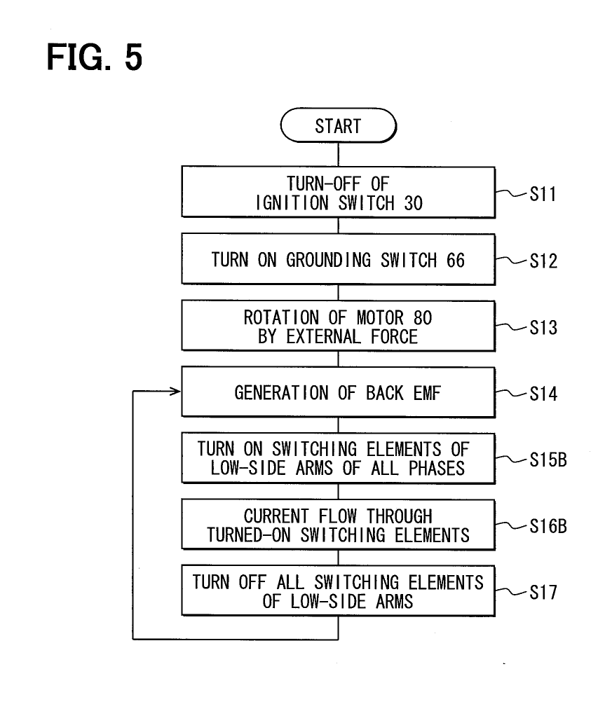

A motor drive apparatus according to a second embodiment is configured as shown in FIG. 4 and FIG. 5. A motor drive apparatus 102 according to the second embodiment is different from that of the first embodiment in the configuration of the protection control circuit unit. In the following description of the embodiment, the same configuration as the foregoing embodiment is designated by the same reference numerals to simplify the description.

As shown in FIG. 4, a protection control circuit 602 includes a signal distribution circuit 65 between the signal detection line 51, 52, 53 of each phase and the anode side of the Zener diode 64. When the back EMF detected by the back EMF detection element 71, 72, 73 exceeds the threshold voltage Vt in any of the phases, the voltage signal is applied to the gate 541, 551, 561 of all phases through the signal distribution circuit 65.

Further, as shown in the sequence chart of FIG. 5, the motor drive apparatus 102 performs S15B and S16B in its drive circuit protection processing in place of S15A and S16A of the first embodiment. That is, the switching elements 541, 551, 561 of the low-side arms of all phases are turned on at S15B and S16B, even in a case that the back EMF is high only partly among the plurality of phases. According to the second embodiment, similarly to the first embodiment, the switching elements 51 to 58 in the drive circuit 50 can be protected from the excessive voltage by lowering the back EMF.

### Other Embodiment

(A) The bridge circuit of the inverter circuit is not limited to the three-phase inverter circuit but may be a half-bridge circuit, which is formed of four switching elements. The half-bridge circuit is incorporated in, for example, a drive apparatus for a brush motor. The inverter circuit may have four or more phases.

(B) The threshold voltage setting circuit is not limited to the Zener diode but may be provided in different configuration.

(C) The semiconductor switching element may be any element other than the MOSFET, as long as it has the parasitic diode.

(D) The motor drive apparatus described above is not limited to incorporation for the steering assist motor of the electric power steering system but may be incorporated for other motors.

The motor drive apparatus may be further implemented in other modified embodiments.

What is claimed is:

1. A motor drive apparatus for a motor of a plurality of phases, the motor drive apparatus comprising:
a drive circuit, which includes a plurality of switching elements forming a high-side arm and a low-side arm of a bridge circuit and drives the motor by converting electric power of a DC power source;
a power supply on/off circuit, which conducts and interrupts electric connection between the DC power source and the drive circuit;
a drive control circuit, which controls the plurality of switching elements to turn on and off when the drive circuit drives the motor, and turns off the plurality of switching elements when the electric connection is interrupted by the power supply on/off circuit;
a back EMF detection circuit, which detects whether a back EMF is generated with respect to each phase; and
a protection control circuit, which turns on at least the switching element forming the low-side arm of a predetermined phase, when the back EMF detection circuit detects the back EMF in any one of the phases under a state of interruption of the electric connection by the power supply on/off circuit, the predetermined phase corresponding to the phase in which the back EMF is detected.

2. The motor drive apparatus according to claim 1, wherein:
the protection control circuit turns on all of the switching elements forming the low-side arms, when the back EMF detection circuit detects that the back EMF is excessive in any one of the phases under the state of interruption of the electric connection by the power supply on/off circuit.

3. The motor drive apparatus according to claim 1, wherein:
the protection control circuit includes a detection signal line, which connects a sensing gate of the switching element forming the low-side arm of the drive circuit and the back EMF detection circuit, a threshold voltage setting circuit, which sets a predetermined threshold voltage for the back EMF detected by the back EMF detection circuit, and a connection switch, which connects electrically the sensing gate and a ground through a resistor when the electric connection is interrupted by the power supply on/off circuit; and
the protection control circuit turns on the switching element, to the sensing gate of which a voltage signal is applied through the detection signal line, when the back EMF detection circuit detects the back EMF in excess of the predetermined threshold voltage in any one of the phases under the state of interruption of the electric connection by the power supply on/off circuit.

4. An electric power steering system comprising:
the motor drive apparatus according to claim 1;
a steering assist motor, which generates a steering assist torque for assisting a steering force of a driver; and
a power transfer device, which transfers a rotation of the steering assist motor to a steering shaft.
